(19) United States
(12) Patent Application Publication
(10) Pub. No.: US 2018/0032313 A1
(43) Pub. Date: Feb. 1, 2018

(54) METHOD FOR ACCESSING ACCESSIBLE ARTICLE, AND SYSTEM AND ACCESSIBLE ARTICLE USING THE SAME

(71) Applicant: ABLE WORLD INTERNATIONAL LIMITED, Tortola (VG)

(72) Inventors: WAI-TUNG CHEUNG, Hong Kong (HK); CHUN-HSIAO LIN, New Taipei City (TW); HO-CHEUNG CHEUNG, Hong Kong (HK)

(21) Appl. No.: 15/535,287

(22) PCT Filed: Dec. 11, 2015
(86) PCT No.: PCT/CN2015/097135

§ 371 Date: Jun. 12, 2017

Related U.S. Application Data
(63) Continuation of application No. 14/577,772, filed on Dec. 19, 2014, now Pat. No. 9,626,157.

(30) Foreign Application Priority Data
Dec. 12, 2014 (CN) 201410768564.X
Dec. 18, 2014 (CN) 201410796528.4
Dec. 23, 2014 (CN) 201410814138.5
Feb. 5, 2015 (CN) 201510061132.X

(51) Int. Cl. G06F 9/44

(52) U.S. Cl. CPC G06F 8/20; G06F 8/35

(57) ABSTRACT

A method for accessing an accessible article, and a system and an accessible article using the method are provided. The user can establish authentication between the user device and the accessible article via the projectable space instance containing the space ID. Consequently, the user device acquires the access right to the accessible article. Under this circumstance, the user can control and manage the accessible article via the user device and receive associated inner information from the accessible article.

### TECHNICAL FIELD

The present invention relates to a method for accessing an accessible article, and more particularly to a method for accessing an accessible article via a workspace.

### BACKGROUND

In 2005, the ITU-T (ITU Telecommunication Standardization Sector) announced an annual report “The Internet of Things”. In the annual report, it was predicted that the internet of things (IOT) would be the most fundamental frame containing all structures of future IT industry revolution. The report defined the IOT as “a new information communication infrastructure that connects all kinds of things existing in the world through networks and enables persons and things to communicate with each other anytime and anywhere”. That is, the IOT can truly be seen as an infrastructure to realize a ubiquitous space. Such a ubiquitous space starts by implanting computing devices to equip specific functions into environments and things and make the environment and the things intelligent. Therefore, the IOT is an important component of the next generation information technology and particularly refers to object-interconnecting networks.

The objective of the IOT is to realize connections between objects, objects and persons, all things and networks for the convenience of identification, management and control. For example, a user could use the computer or smart phone via internet to control/manage the devices such as home appliances or machines. In the IOT, it is very important to securely control/manage the IOTs. At present, the user gets a personal right of controlling/managing the IOT via an authentication process. However, the authentication process of the IOT may be restricted to only the user account and it is very difficult for the user to share or agree with other users to control/manage an accessible article of the IOT if an appropriate authentication approach is not taken.

Besides, each IOT may be created by different companies. Therefore, the information or services of each IOT may include different capabilities, different attributes or different expression styles. The user needs to use many applications or web servers to browse or obtain the information of each IOT. Without a unified workspace or application in a user terminal to integrate the heterogeneous services in the IOTs, managing the information of the IOTs may become difficult or even not accomplishable.

From the above discussions, the conventional IOT technology needs to be further improved.

### SUMMARY

The present invention provides a method for accessing an accessible article. The user can establish authentication between a user device and the accessible article via a projectable space instance containing the space ID. Consequently, the user device acquires the access right to the accessible article.

In accordance with an aspect of the present invention, there is provided a method for accessing an accessible article. The method includes the following steps. In a step (a), projectable space instance for modeling a workspace is provided to manage an access right to the accessible article. In a step (b), the projectable space instance is parsed, so that the workspace is projected to a user device. In a step (c), a space ID is acquired from the projectable space instance, the space ID is wrapped as an authentication request, and the authentication request is transmitted to the accessible article before the accessible article is accessed. Then, a step (d) is performed to check whether a provisioned space ID exists in the accessible article. In a step (e), if the provisioned space ID exists in the accessible article, the accessible article performs an authenticating process to compare the space ID wrapped in the authentication request with the provisioned space ID in the accessible article, wherein the user device is allowed to access the accessible article if the space ID wrapped in the authentication request matches the provisioned space ID in the accessible article. Moreover, if the provisioned space ID does not exist in the accessible article, the space ID wrapped in the authentication request is stored into the accessible article to have the space ID become the provisioned space ID, and the user device is allowed to access the accessible article. Alternatively, if the provisioned space ID does not exist in the accessible article, the space ID wrapped in the authentication request is stored into the accessible article to have the space ID become the provisioned space ID, and the accessible article performs an authenticating process to compare the space ID wrapped in the authentication request with the provisioned space ID in the accessible article, wherein the user device is allowed to access the accessible article if the space ID wrapped in the authentication request matches the provisioned space ID in the accessible article.

In an embodiment, the method further includes a step (b1) of obtaining a unified tool for linking the accessible article via the user device, and adding the unified tool to the projectable space instance via the projected workspace, wherein the step (b1) is performed before the step (c).

In an embodiment, the unified tool is a produced after a driver is unified, and the driver is provided from the accessible article or another device so as to transmit the authentication request.

In an embodiment, in the step (e), if the space ID wrapped in the authentication request does not match the provisioned space ID in the accessible article, the accessible article rejects the user device to access the accessible article.

In an embodiment, the accessible article is a remotely-controllable electronic device.

In an embodiment, the user device is a computer, a portable electronic device or a smart wearable device.

In an embodiment, the projectable space instance is instantiated by a unified script, which is used as an intermediate language for implementing the workspace.

In an embodiment, an information importer, a unified tool and/or a unified information unit is provided to the workspace via the unified script.

In an embodiment, the projectable space instance has a uniform resource identifier to be transmitted.

In an embodiment, the projectable space instance is parsed when the uniform resource identifier is opened, so that the workspace is projected to the user device.

In an embodiment, in the step (b), a projector is used to parse the projectable space instance to build a working environment, wherein an information importer, a unified tool and/or a unified information unit is configured in the projectable space instance via the working environment.

In an embodiment, if the space ID wrapped in the authentication request matches the provisioned space ID in the accessible article and a first user of the user device shares an authority of the projectable space instance with a second user, the second user acquires the access right to the accessible article.

In an embodiment, the first user has an authority to cancel the access right of the second user to the accessible article.

In an embodiment, the provisioned space ID is reset as needed.

In an embodiment, the projectable space instance contains a driver corresponding to the accessible article and an additional driver corresponding to an additional accessible article, wherein the accessible article and the additional accessible article are accessed by the driver and the additional driver, respectively.

In an embodiment, the space ID is a content or an image.

In accordance with another aspect of the present invention, there is provided a system. The system includes an accessible article and a user device. After a projectable space instance for managing an access right to the accessible article is loaded to the user device and the parsed, a projected workspace is created in the user device. The projected workspace acquires a space ID from the projectable space instance, wraps the space ID as an authentication request, and transmits the authentication request to the accessible article before the accessible article is accessed. After the accessible article receives the authentication request, the accessible article checks whether a provisioned space ID exists in the accessible article. If the provisioned space ID exists in the accessible article, the accessible article performs an authenticating process to compare the space ID wrapped in the authentication request with the provisioned space ID in the accessible article. The user device is allowed to access the accessible article if the space ID wrapped in the authentication request matches the provisioned space ID in the accessible article. Moreover, if the provisioned space ID does not exist in the accessible article, the space ID wrapped in the authentication request is stored into the accessible article to have the space ID become the provisioned space ID, and the user device is allowed to access the accessible article. Alternatively, if the provisioned space ID does not exist in the accessible article, the space ID wrapped in the authentication request is stored into the accessible article to have the space ID become the provisioned space ID, and the accessible article performs an authenticating process to compare the space ID wrapped in the authentication request with the provisioned space ID in the accessible article. The user device is allowed to access the accessible article if the space ID wrapped in the authentication request matches the provisioned space ID in the accessible article.

In an embodiment, a unified tool for linking the accessible article is added to the projectable space instance via the projected workspace.

In an embodiment, the unified tool is a produced after a driver is unified, and the driver is provided from the accessible article or another device so as to transmit the authentication request.

In accordance with a further aspect of the present invention, there is provided an accessible article for receiving an authentication request from a projected workspace of a user device. The projected workspace is created in the user device after a projectable space instance loaded into the user device is parsed. A space ID from the projectable space instance is wrapped as the authentication request. After the accessible article receives the authentication request, the accessible article performs the following steps. Firstly, a step (a) is performed to check whether a provisioned space ID exists in the accessible article. In a step (b), if the provisioned space ID exists in the accessible article, the accessible article performs an authenticating process to compare the space ID wrapped in the authentication request with the provisioned space ID in the accessible article, wherein the user device is allowed to access the accessible article if the space ID wrapped in the authentication request matches the provisioned space ID in the accessible article. Moreover, if the provisioned space ID does not exist in the accessible article, the space ID wrapped in the authentication request is stored into the accessible article to have the space ID become the provisioned space ID, and the user device is allowed to access the accessible article. Alternatively, if the provisioned space ID does not exist in the accessible article, the space ID wrapped in the authentication request is stored into the accessible article to have the space ID become the provisioned space ID, and the accessible article performs an authenticating process to compare the space ID wrapped in the authentication request with the provisioned space ID in the accessible article, wherein the user device is allowed to access the accessible article if the space ID wrapped in the authentication request matches the provisioned space ID in the accessible article.

In an embodiment, a unified tool for linking the accessible article is added to the projectable space instance via the projected workspace.

In an embodiment, the unified tool is a produced after a driver is unified, and the driver is provided from the accessible article or another device so as to transmit the authentication request.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic diagram illustrating an implementation concept of a unifying method according to an embodiment;

FIG. 2 is a schematic diagram illustrating an implementation concept of using the unified script as an intermediate language for implementing the personal workspace;

FIG. 3 is a schematic diagram illustrating a preferred configuration of a personal workspace;

FIG. 4 is a schematic diagram illustrating an initial state of the method of projecting the workspace according to an embodiment of the present invention;

FIGS. 5A and 5B are schematic diagrams illustrating operating concepts of the method of projecting the workspace as shown in FIG. 4;

FIG. 6 is a schematic diagram illustrating the relationship between a projectable space instance as shown in FIG. 4 and a projected workspace as shown in FIG. 5B;

FIG. 7A is a flowchart illustrating a method for accessing an accessible article according to a first embodiment of the present invention;

FIG. 7B is a flowchart illustrating a method for accessing an accessible article according to a second embodiment of the present invention;

FIG. 7C is a flowchart illustrating a method for accessing an accessible article according to a third embodiment of the present invention;

FIG. 8 schematically illustrates an implementation concept of projecting the workspace to the user device;

FIG. 9 schematically illustrates the architecture of a system using the method of FIGS. 7A˜7C;

FIG. 10 schematically illustrates an implementation concept of allowing a user to access plural different accessible articles via the user device; and

FIG. 11 schematically illustrates an implementation concept of allowing a user to share a workspace with other user via the user device of FIG. 10.

### DETAILED DESCRIPTION

The present invention is more fully appreciated by reference to the following description, including the following glossary of terms and the concluding examples. For the sake of brevity, the disclosures of the publications, including patents, cited in this specification are herein incorporated by reference.

The examples below are non-limiting and are merely representative of various aspects and features of the present invention. The term “information source” used herein is defined as a sequence of symbols that can be interpreted as a message in the most limited technical meaning. And the message is used for organizing and labeling information. For example, the information source includes website (such as internet service), intranet, social network, software, electronic book, database and other media of information (such as storage media of non-transitory computer or storage media of mobile device). The term “original information” used herein is a file, a web page, a database row, a policy, a rule or any data accessible in a corresponding machine and server, but is not limited thereto. The term “original tool” used herein is a utility program, a widget, an intelligent agent, an application, a service or any executable component accessible in a corresponding machine and server, but is not limited thereto. It is noted that the information sources, the original information and the original tool are not restricted to the above examples.

Moreover, “original information” and “original tool” are implementation examples of “original matters” used herein. In accordance with the present invention, a plurality of “original matters” from identical or different “information sources” are modeled to a plurality of “unified matters” by a unifying method. Consequently, the “unified matters” in the same execution environment are compatible with each other and cooperate to perform a specified task. The “unified tool” and the “unified information unit” are implementation examples of the “unified matters”. Moreover, the term “Matterizer” used herein is a means, a device or a program code to perform the unifying process.

In an embodiment, the above unifying method comprises steps of: modeling at least one original information obtained from at least one information source of multiple information sources into a unified information unit with one unified data model via re-organizing the original information, and/or modeling at least one original tool obtained from at least one information source of multiple information sources into a unified tool with another unified data model via re-organizing the original tool. The one unified data model and another unified data model could be identical or different, and the unifying method described above could be completed through a matterizer.

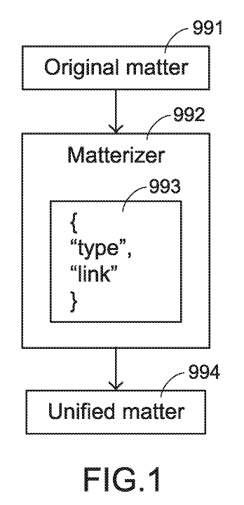

Please refer to FIG. 1. FIG. 1 is a schematic diagram illustrating an implementation concept of a unifying method according to an embodiment. As shown in FIG. 1, the matterizer 992 re-organizes an attribute and a link of an original matter 991 with a unified data model 993, and thus models the original matter 991 into a unified matter 994. Consequently, the basic attribute of the unified matter 994 include a type of the original matter 991 and a link indicating where the original matter 994 is located.

In this embodiment, the original matter 991 at least includes an original information (not shown) or an original tool (not shown), but is not limited thereto. In the above unifying method, if the attribute accessible from the original information corresponds to the attribute to be unified in the unified information unit, the unified information unit is directly produced through the matterizer 992. If the attribute accessible from the original information does not correspond to the attribute to be unified in the unified information unit, the original information is firstly re-defined by logically re-organizing the attributes and the link of the original information, and then the original information is converted into a new original information with the attributes which correspond to attributes to be unified in the unified information unit. Consequently, the unified information unit is indirectly produced.

Moreover, if the original tool is compatible with the working environment of the workspace, the unified tool is directly produced by the matterizer 992. On the other hand, if the original tool is incompatible with the working environment of the workspace, the unified tool is indirectly produced via an adapter and/or a software development kit (SDK) of the original tool to drive the original tool. The adapter provides an interface implementation compatible with the working environment.

Herein, “the descriptions of the unifying method”, “the methods of obtaining the unified matters” and “the descriptions of the matterizer” may be referred to the U.S. patent application Ser. No. 14/324,069, entitled “A method of unifying information and tool from a plurality of information sources”, and also referred to the China Patent Application No. 201410768564.X, entitled “A method of unifying information and tool from a plurality of information sources and computer product and device using the method”. The detailed descriptions thereof are omitted.

The above unifying method is presented herein for purpose of illustration and description only. The method of unifying a plurality of original matters from different information sources is not restricted. However, those skilled in the art will readily observe that numerous modifications and alterations may be made while retaining the teachings of the invention.

Hereinafter, two other unifying methods will be illustrated. The first unifying method is applied to a method of unifying the information of Garmin satellite navigation. Through a point-of-interest (POI) function of the Garmin satellite navigation, the method of unifying the information is employed to unify the imported original point information (i.e., an original information) into the corresponding unified point information (i.e., a unified information unit). The second unifying method is applied to a method of unifying the tool of an Android system. The Android system is a Linux-based open source mobile operating system. However, most application programs (i.e., original tools) are written in the Java programming language. Consequently, the application program (i.e., the original tool) written in the Java programming language can be modelled into a unified application program (i.e., the unified tool) compatible with the Android system so as to be executed in the Android system.

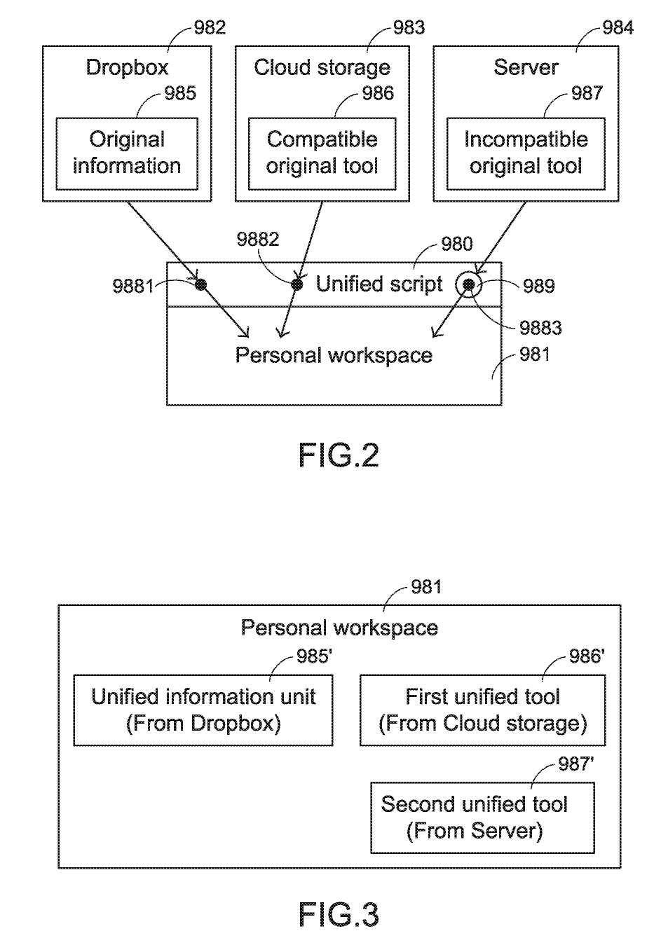

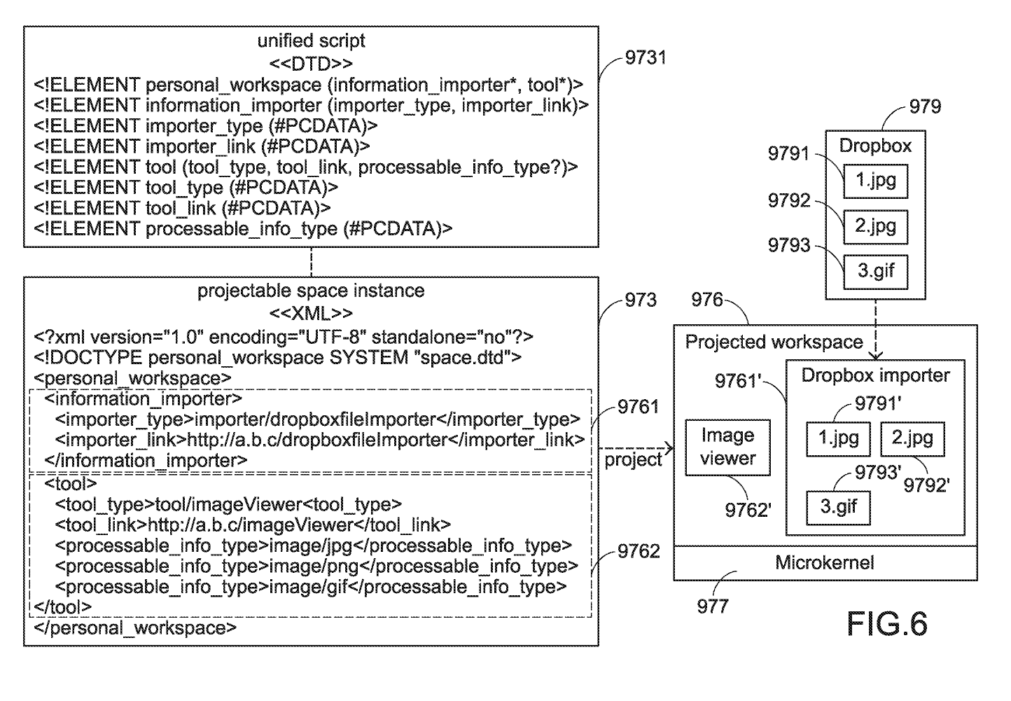

The term “workspace” used herein is a working environment for providing interactions among the at least one matterizer, the at least one tool and/or the at least one information so as to implement a specified task. Moreover, the at least one tool and/or at least one information can be imported into the workspace through the at least one matterizer. However, the way of importing the information and/or tool into the workspace is not restricted. Hereinafter, information importers such as the information importers 9881, 9882 and 9883 of FIG. 2 and the Dropbox importer 9761′ of FIG. 6 are some examples of the matterizer. The term “unified script” used herein is an intermediate language to implement the workspace. Moreover, via the “unified script”, the at least one matterizer, the at least one tool and/or the at least one information can be provided to the workspace (e.g., built in or plugged in the workspace).

In an embodiment, the above at least one information is a unified information unit which is produced after at least one original information obtained from at least one information source is unified, and the above at least one tool is a unified tool which is produced after at least one original tool obtained from at least one information source is unified. Moreover, according to different tasks, the required unified information unit and/or the required unified tool from the corresponding information source can be added to the personal workspace (e.g., built in or plugged in the personal workspace). In other words, the “workspace” is a user-orientated “personal workspace”.

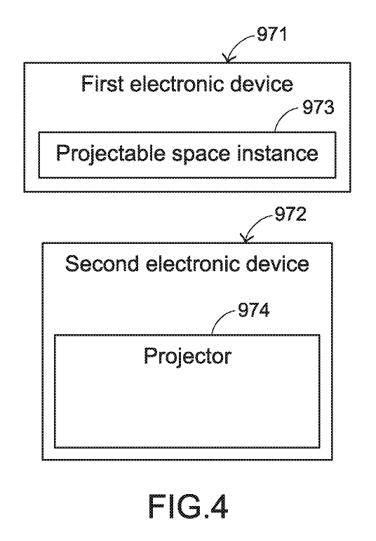

Please refer to FIG. 2 and FIG. 3. FIG. 2 is a schematic diagram illustrating an implementation concept of using the unified script as an intermediate language for implementing the personal workspace. FIG. 3 is a schematic diagram illustrating a preferred configuration of a personal workspace. As shown in FIG. 2 and FIG. 3, a unified information unit 985′ corresponding to an original information 985 in Dropbox 982, a first unified tool 986′ corresponding to a compatible original tool 986 in a cloud storage 983 and a second unified tool 987′ corresponding to an incompatible original tool 987 in a server 984 are combined together into a personal workspace 981 according to the required tasks. In particular, a unified script 980 as an intermediate language for implementing the personal workspace 981 is firstly compiled, and then an information importer 9881 of the Dropbox 982, an information importer 9882 of the cloud storage 983 and an information importer 9883 of the server 984 are configured through the unified script 980. Moreover, after the original information 985 in the Dropbox 982 is unified into the unified information unit 985′ by the information importer 9881, the unified information unit 985′ is imported into the personal workspace 981.

As shown in FIG. 2 and FIG. 3, the original tool stored in the cloud storage 983 is the compatible original tool 986, which is compatible with the component architecture of the unified tool in the personal workspace 981. Moreover, the first unified tool 986′ corresponding to the compatible original tool 986 is directly provided to the personal workspace 981 through the information importer 9882 of the unified script 980.

As shown in FIG. 2 and FIG. 3, the original tool stored in the server 984 is the incompatible original tool 987, which is incompatible with the component architecture of the unified tool in the personal workspace 981. Moreover, the second unified tool 987′ corresponding to the incompatible original tool 987 is provided to the personal workspace 981 through the compatible adapter 989 and the information importer 9883 of the unified script 980.

As shown in FIG. 3, the user can configure and arrange (e.g., group or place) the unified information unit 985′, the first unified tool 986′ and the second unified tool 987′ in a specific area of the personal workspace 981 according to the practical requirements. Moreover, according to the operational relationship between the unified tool and the unified information unit (e.g., the clicking or dragging actions between the two), the user can perform specified tasks by using the unified tool to access or control the corresponding unified information unit.

Herein, “the descriptions of using the unified script as the intermediate language for implementing the personal workspace” and “the descriptions of allowing the required unified information unit and/or the required unified tool from the corresponding information sources to be arbitrarily combined together into the personal workspace according to the practical requirements” may be referred to the U.S. patent application Ser. No. 14/325,466, entitled “Method for performing task on unified information units in a personal workspace”, and also referred to the China Patent Application No. 201410796528.4, entitled “A method of combining unified matters in a personal workspace and computer product and device using the method”. The detailed descriptions thereof are omitted.

The above personal workspace is presented herein for purpose of illustration and description only, and it is noted that the applications of the workspace in the present invention is not restricted. For example, the unified script as the intermediate language for implementing the workspace can be previously edited. Consequently, the workspace equips the default matterizer, the default information and/or the default tool. This workspace is not limited to be operated by a single user. According to the practical requirements, this workspace can be operated by multiple users at the same time or at different times.

Moreover, the “workspace” used herein is obtained by “a method of projecting a workspace” to any electronic device with computational capability. An example of the electronic device includes but is not limited to a mobile phone, a tablet computer, a notebook computer or a desktop computer. Consequently, the “projected workspace” can be operated by any user through any electronic device with computational capability.

In an embodiment, the method of projecting the workspace comprises the following steps. Firstly, a projectable space instance instantiated by the unified script is obtained through a uniform resource identifier (URI). As mentioned above, the unified script is defined to configure at least one of the matterizer, the information and the tool to model the workspace. Moreover, the projectable space instance is used to build the projected workspace corresponding to the workspace, and thus provide an interface for operating at least one of the matterizer, the information and the tool to implement a task. Then, a projector parses the projectable space instance and build a working environment to configure at least one of the matterizer, the information and the tool so as to execute the projected workspace for providing interactions between at least one user and the projected workspace.

The projector is acquired from a remote data station, the projectable space instance or a preloaded application program, and loaded into an engine for providing a compatible environment to execute the projector. An example of the engine includes but is not limited to a Javascript engine, a Windows application or a Linux application. Preferably but not exclusively, the unified script can be declared by a document type definition (DTD), an extensible markup language (XML) Schema, a structured language or a structured protocol. Preferably but not exclusively, the projectable space instance is an object, an extensible markup language (XML) document, or an instance instantiated with a structured language or a structured protocol.

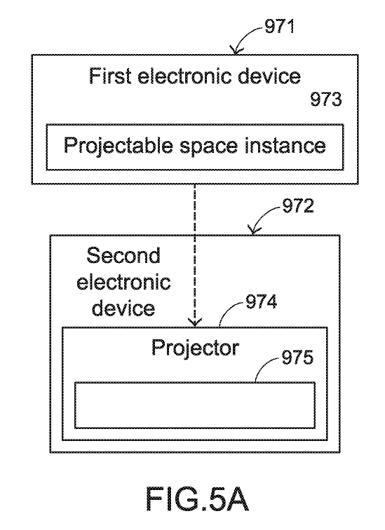

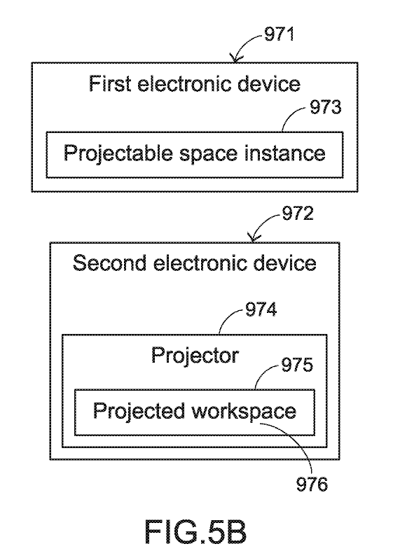

Please refer to FIG. 4, FIG. 5A, FIG. 5B and FIG. 6. FIG. 4 is a schematic diagram illustrating an initial state of the method of projecting the workspace according to an embodiment of the present invention. FIGS. 5A and 5B are schematic diagrams illustrating operating concepts of the method of projecting the workspace as shown in FIG. 4. FIG. 6 is a schematic diagram illustrating the relationship between a projectable space instance as shown in FIG. 4 and a projected workspace as shown in FIG. 5B.

In the initial state of FIG. 4, a first electronic device 971 and a second electronic device 972 are in communication with each other (e.g., through network connection). Moreover, the first electronic device 971 stores a projectable space instance 973, and the second electronic device 972 has a built-in projector 974.

In this embodiment, the unified script 9731 is declared by a document type definition (DTD) and defined to configure at least one information importer (i.e., an example of the matterizer), at least one unified information unit and/or at least one unified tool to model a workspace, and the projectable space instance 973 is an instance instantiated with the extensible markup language (XML). As shown in FIG. 6, the projectable space instance 973 is used for building a projected workspace 976 corresponding to the workspace. Moreover, the information importer, the unified information and/or the unified tool is allowed to be added to or removed from the projectable space instance 973.

The projector 974 of the second electronic device 972 will build a working environment 975 in the second electronic device 972 for executing the projected workspace 976. In addition, the projector 974 provides a microkernel 977 (see FIG. 6) to the working environment 975 for equipping at least one information importer, at least one unified information and/or at least one unified tool that will be added to the projected workspace 976. When the second electronic device 972 acquires the projectable space instance 973 from the first electronic device 971 through a URI, the projector 974 of the second electronic device 972 starts to parse the projectable space instance 973 (see FIG. 5A). After the projectable space instance 973 is parsed by the projector 974, the projected workspace 976 is built in the working environment 975 according to parsed contents of the projectable space instance 973 (see FIG. 5B). Accordingly, a user of the second electronic device 972 can interact with the projected workspace 976 through the second electronic device 972 so as to perform related tasks.

The relationships between the unified script 9731, the projectable space instance 973 and the projected workspace 976 will be illustrated in more detailed through a usage situation as shown in FIG. 6. The usage situation as shown in FIG. 6 is related to a process of building a projected workspace that is capable of accessing jpg format image files and gif format image files from a specified internet space and allowing the image files to be viewed by a user. In this usage situation, the unified script 9731 is declared by the Document Type Definition (DTD), and the projectable space instance 973 is instantiated with XML.

Moreover, an information importer and a unified tool are added into the projectable space instance 973, and at least one unified information unit corresponding to the original information is imported into the projected workspace 976 through the information importer. In this usage situation, the information importer is a Dropbox importer. The information of the Dropbox importer is disclosed in the dashed line frame 9761 of FIG. 6. The original information includes a jpg format image file 9791, a jpg format image file 9792 and a gif format image file 9793 in Dropbox 979 (i.e., an information source). The unified information units includes a unified jpg format image file 9791′, a unified jpg format image file 9792′ and a unified gif format image file 9793′, which will be described later. The unified tool is an image viewer for accessing image files which are imported into the projected workspace 976. The information of the image viewer is disclosed in the dashed line frame 9762 of FIG. 6.

As mentioned above, the projected workspace 976 is built after the projectable space instance 973 is parsed by the projector 974 of the second electronic device 972. In this embodiment, the Dropbox importer 9761′ corresponding to the dashed line frame 9761 and the image viewer 9762′ corresponding to the dashed line frame 9762 are configured in the projected workspace 976. Moreover, the jpg format image file 9791, the jpg format image file 9792 and the gif format image file 9793 in Dropbox 979 are unified and imported into the projected workspace 976 by the Dropbox importer 9761′. Consequently, the unified jpg format image file 9791′ corresponding to the jpg format image file 9791, the unified jpg format image file 9792′ corresponding to the jpg format image file 9792 and the unified gif format image file 9793′ corresponding to the gif format image file 9793 are displayed on the projected workspace 976. When the user of the second electronic device 972 manipulates any of the unified image files 9791′, 9792′ and 9793′ by any specified operating means (such as an action of clicking any of the unified images files 9791′, 9792′ and 9793′ or an action of dragging and dropping any of the image files 9791′, 9792′ and 9793′ to the image viewer 9762′), the image viewer 9762′ will access the contents of the corresponding unified image files 9791′, 9792′ or 9793′ to allow the unified image files 9791′, 9792′ or 9793′ to be viewed by the user. Moreover, the Dropbox importer 9761′ and the image viewer 9762′ mentioned above are equipped by the microkernel 977.

It is noted that the URI of the projectable space instance 973 may be a HTTP (hypertext transfer protocol) URI or a FTP (file transfer protocol) URI. In case that the first electronic device 971 and the second electronic device 972 are integrated into one device, the URI of the projectable space instance 973 can also be a local file URI. However, the types of the URI of the projectable space instance 973 are not restricted.

Herein, “the descriptions of the method of projecting the workspace” may be referred to the U.S. patent application Ser. No. 14/577,772, entitled “Method of projecting a workspace and system using the same”, and also referred to the China Patent Application No. 201410814138.5, entitled “Method of projecting a workspace and system using the same”. The detailed descriptions thereof are omitted.

The above method of projecting the workspace to any electronic device with computational capability is presented herein for purpose of illustration and description only. The method of projecting the workspace to any electronic device with computational capability is not restricted. However, those skilled in the art will readily observe that numerous modifications and alterations may be made while retaining the teachings of the invention.

The present invention provides a method for accessing an accessible article. The present invention will now be described more specifically with reference to the following embodiments. It is to be noted that the following descriptions of preferred embodiments of this invention are presented herein for purpose of illustration and description only.

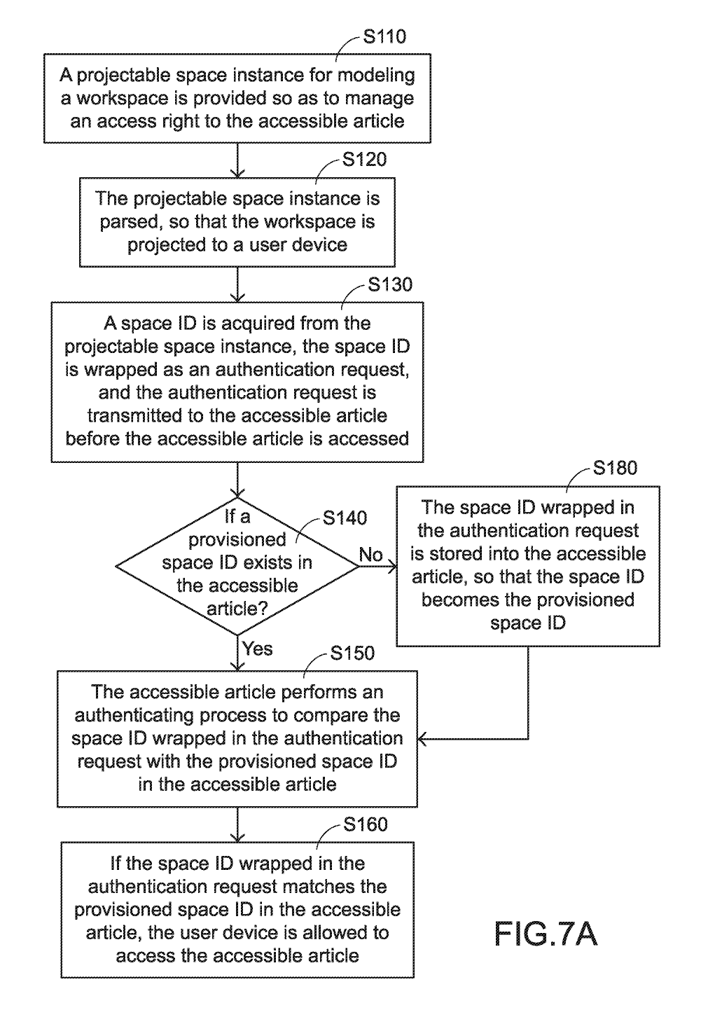

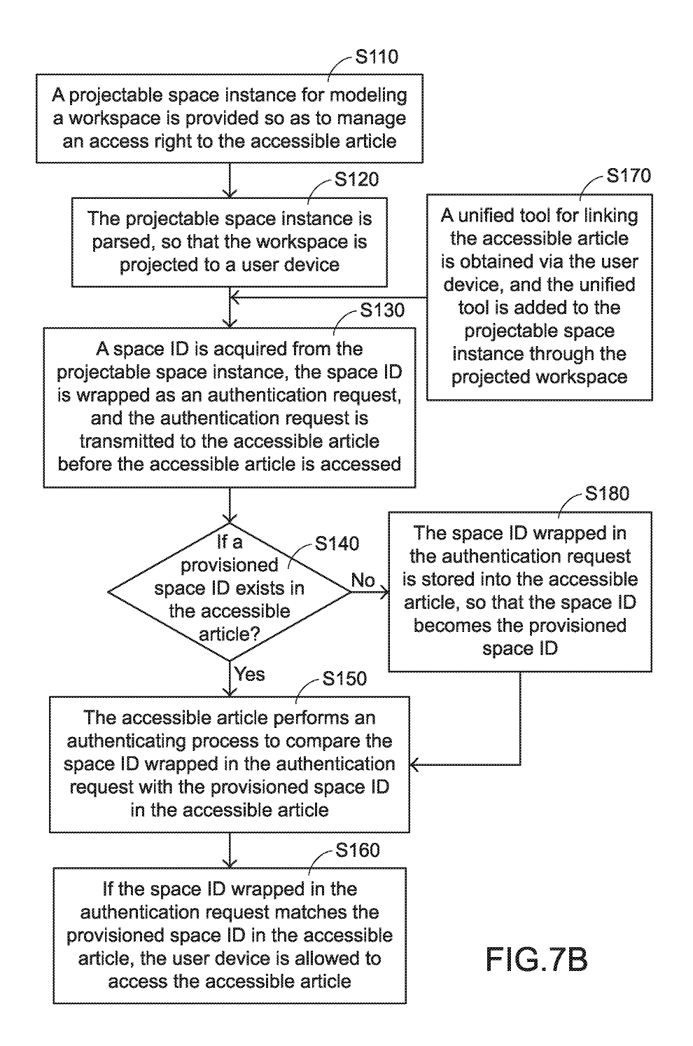

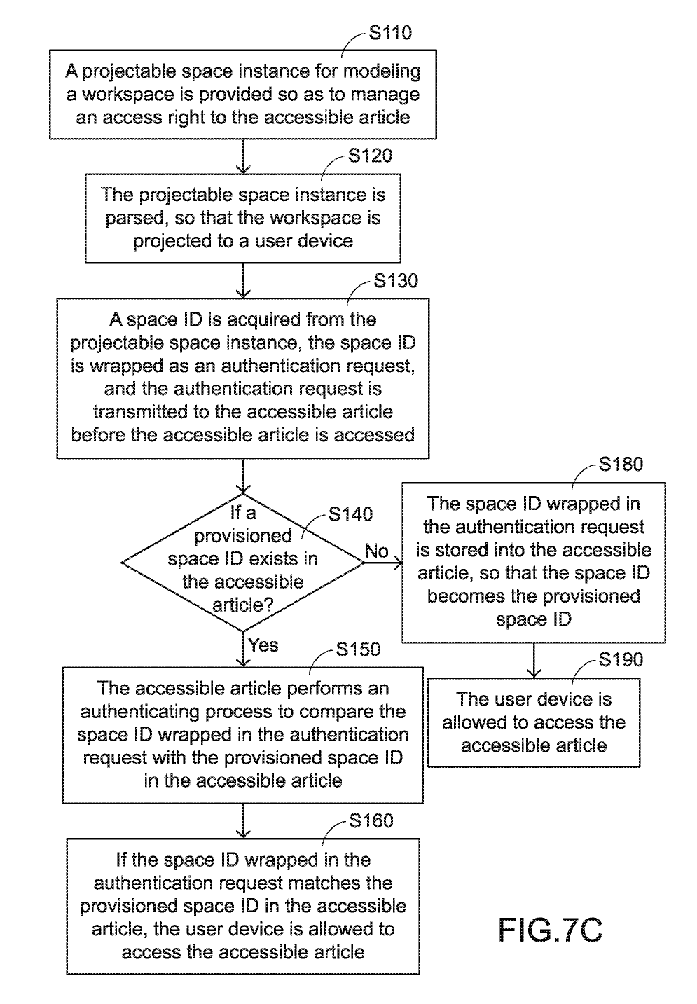

FIG. 7A is a flowchart illustrating a method for accessing an accessible article according to a first embodiment of the present invention. The method comprises the following steps. Firstly, a projectable space instance for modeling a workspace is provided so as to manage an access right to the accessible article (Step S110). Then, the projectable space instance is parsed, so that the workspace is projected to a user device (Step S120). Then, a space ID is acquired from the projectable space instance, the space ID is wrapped as an authentication request, and the authentication request is transmitted to the accessible article before the accessible article is accessed (Step S130). Then, a step S140 is performed to check whether a provisioned space ID exists in the accessible article. If the provisioned space ID exists in the accessible article, the next step S150 is performed. Whereas, if the provisioned space ID does not exist in the accessible article, the space ID wrapped in the authentication request is stored into the accessible article, so that the space ID becomes the provisioned space ID (Step S180). After the step S180, the next step S150 is performed. In the step S150, the accessible article performs an authenticating process to compare the space ID wrapped in the authentication request with the provisioned space ID in the accessible article. If the space ID wrapped in the authentication request matches the provisioned space ID in the accessible article, the user device is allowed to access the accessible article (Step S160).

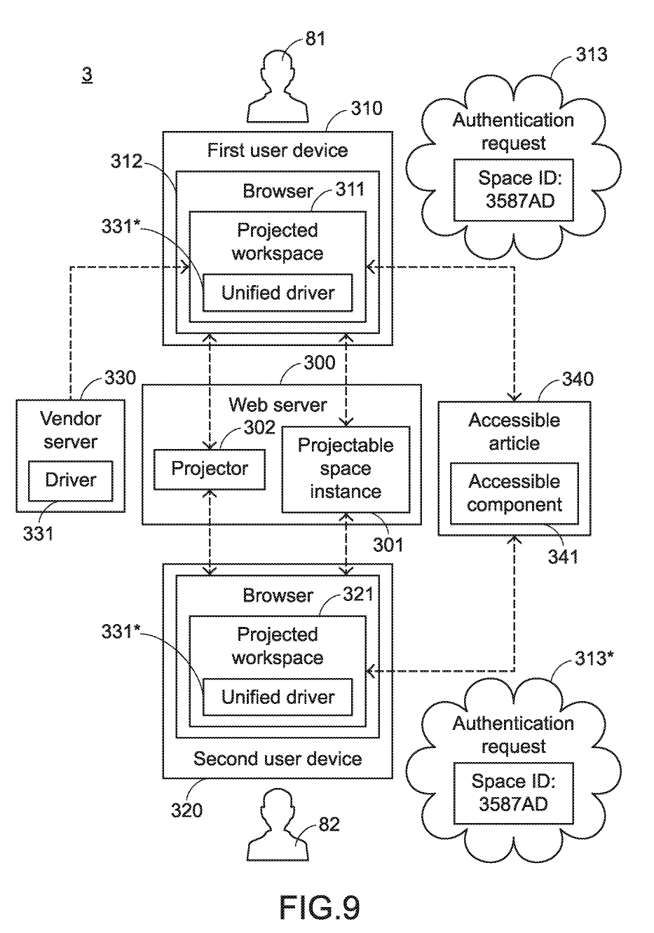

It is noted that numerous modifications and alterations may be made while retaining the teachings of the invention. FIG. 7B is a flowchart illustrating a method for accessing an accessible article according to a second embodiment of the present invention. In comparison with the method of FIG. 7A, the method of this embodiment further comprises a step S170. The step S170 is intervened between the step S120 and the step S130. In the step S170, a unified tool for linking the accessible article is obtained via the user device, and the unified tool is added to the projectable space instance through the projected workspace. In an embodiment, the unified tool used in the step S170 is a unified driver (e.g., the unified driver 331* as shown in FIG. 9) after a driver (e.g., the driver 331 shown in FIG. 9) is unified. Moreover, the driver is provided from the accessible article or other devices (e.g., a vendor server 330 as shown in FIG. 9). The driver is used for transmitting the authentication request in the step S130.

The term “driver” used herein means a program that has a common communication protocol with the accessible article. Consequently, the driver enables the user device to link to the accessible article so as to transmit authentication request and access the accessible article. However, in the method of FIG. 7B, the way of acquiring the driver of the accessible article from the accessible article or other devices is presented herein for purpose of illustration and description only. In another embodiment, the driver is previously embedded into the user device to enable the user device to directly link with the accessible article.

FIG. 7C is a flowchart illustrating a method for accessing an accessible article according to a third embodiment of the present invention. In comparison with the method of FIG. 7A, the method of this embodiment further comprises a step S190. The step S190 is performed after the step S180. In the step S190, the user device is allowed to access the accessible article.

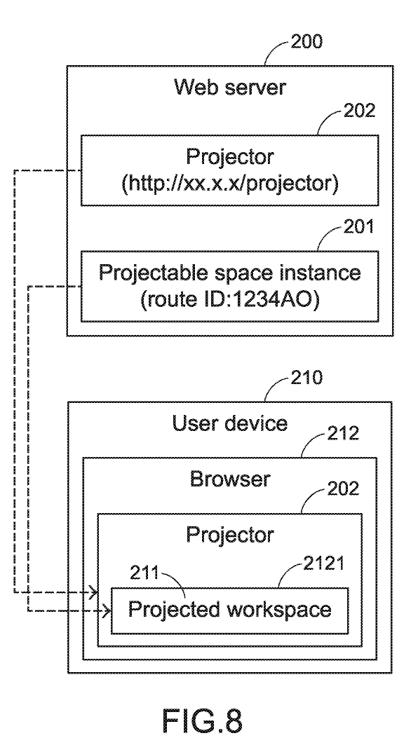

The operations of the methods of FIGS. 7A˜7C will be described in more details as follows. FIG. 8 schematically illustrates an implementation concept of projecting the workspace to the user device. As shown in FIG. 8, a storage device provides a projectable space instance 201 and a projector 202. The projectable space instance 201 is accessible through a route ID (e.g. ID:1234AO). The projector 202 is accessible through a link http://xx.x.x/projector. In this embodiment, the storage device is a web server 200. In another embodiment, the storage device is network attached storage (NAS) device that is hosted in a highly secure place.

In this embodiment, the user device 210 has a browser 212. The browser 212 is connected to the web server 200. The web server 200 is created by an AJAX language. The web server 200 is able to provide the URL of the projector 202, i.e., http://xx.x.x/projector. In this embodiment, the uniform resource identifier (URI) corresponding to the projectable space instance is “http://xx.xx/projector#!/1234AO”. The URI corresponding to the projectable space instance can be received by the user device 210 through a public communication channel such as Line, Whatsapp, Skype, Facebook, Gtalk, messenger and/or any channel capable of transmitting the URI. Consequently, the projectable space instance 201 is loaded to the user device 201. In another embodiment, the user of the user device 210 can acquire the projectable space instance 201 after registering and logging in the web server.

When the user opens the URI corresponding to the projectable space instance 201 through a browser 212, the browser 212 loads the projector 202 from the web server 200 containing the link http://xx.x.x/projector. Consequently, a working environment 2121 for executing the projected workspace 211 is built in the browser 212 by the projector 202. In addition, the projector 201 provides a microkernel (not shown) corresponding to the projected workspace 211. Then, the projector 202 starts to parse the projectable space instance 201. After the projectable space instance 201 is parsed by the projector 202, the projected workspace 211 is built in the working environment 2121 according to the contents parsed by the projector 202.

The communication paths or communication modes between the user device 210 and these servers (e.g., the web server 200 as shown in FIGS. 8 and 9 and the vendor server 330 as shown in FIG. 9) are implemented by way of a network. An example of the network includes but is not limited to a cellular network, a telephone network, an open network such as an internet, or a private network such as an intranet and/or an extranet, or a combination thereof. In an embodiment, the network uses standard Internet communications technologies and/or protocols. Thus, the network transmits information or data using the following technologies such as Ethernet, integrated services digital network (ISDN), asynchronous transfer mode (ATM), etc. Similarly, the network protocols used on the network include the transmission control protocol/internet protocol (TCP/IP), the hypertext transport protocol (HTTP), the simple mail transfer protocol (SMTP), the file transfer protocol (FTP), the extensible messaging and presence protocol (XMPP), etc. The data exchanged over the network can be represented by using the following technologies or formats, the hypertext markup language (HTML), the extensible markup language (XML), JavaScript object notation (JSON), the really simple syndication (RSS), etc. As for the network security maintenance, all or some links can be encrypted by using conventional encryption technologies, such as the secure sockets layer (SSL), transport layer security (TLS), secure HTTP (HTTPS) and/or virtual private networks (VPNs). It is noted that the technologies for transmitting information or data between the user device 210 and the servers, the network protocols, the technologies about the data exchanged over the network and the network security maintenance technologies are not restricted. Those skilled in the art will readily observe that numerous modifications and alterations may be made according to the practical requirements.

FIG. 9 schematically illustrates the architecture of a system using the method of FIGS. 7A˜7C. As shown in FIG. 9, the system 3 comprises a network server 300, a first user device 310, a second user device 320, a vendor server 330 and an accessible article 340. The first user device 310 and the second user device 320 are computing devices or any devices capable of transmitting data via a network. Examples of the first user device 310 and the second user device 320 comprise but are not limited to computers (e.g., desktop computers, notebook computers or table computers), portable electronic devices (e.g., smart phones or personal digital assistants), smart wearable devices (e.g., smart washes, smart wristbands or smart glasses) or other internet accessible devices. Preferably but not exclusively, the accessible article 340 is a remotely-controllable electronic device such as a home appliance, a remote-controlled model, a transportation carrier, a medical device, a firefighting device or a security device.

Moreover, when a first user 81 operates the first user device 310 and opens a browser 312 of the first user device 310, a projector 302 and a projectable space instance 301 are acquired. The projectable space instance 301 contains an identification code, i.e., the space ID: 3587AD. In this embodiment, the space ID is expressed by a content. It is noted that the form of the space ID is not restricted. For example, the space ID may be expressed by an image or any other comparable context.

An example of the basic structure of the projectable space instance 301 will be illustrated as follows:

```
  <workspace>
    <tool> *¹
      <tool type>
      <tool link>
    </tool>
    < space ID >
      <space ID=″3587AD″>
    < /space ID >
</workspace>
```

In the above basic structure of the projectable space instance 301, the note *1 means a unified tool that is loaded to the projected workspace 311. In this embodiment, the unified tool is produced after a driver 331 is unified. The unified tool is used for accessing the corresponding accessible article.

Moreover, the first user 81 can operate the first user device 310 to detect and search a nearby accessible article 340, and a driver 331 of the accessible article 340 can be acquired from the vendor server 330. That is, the vendor server 330 includes but is not limited to a server provided by the manufacturer or the agent of the accessible articles 340. The vendor server 330 provides the driver 331 with a link http://a.b.c/driver. The driver 331 has the functions of communication linking, accessing, controlling and managing the accessible article such as a television (TV). During operations of the system 3, the driver 331 from the vendor server 330 is configured in a projected workspace 311 of the first user device 310 by the first user 81, and then the link and type of the driver 331 are correspondingly loaded into the projectable space instance 301. Consequently, the driver 331 is unified into the unified driver 331*. Moreover, the unified driver 331* is directly provided from the projected workspace 311 to the web server 300 through an HTTP authentication request. Thus, the original content of the projectable space instance 301 is updated, and the updated content of the projectable space instance 301 is stored into the web server 300. The updated content of the projectable space instance 301 will be illustrated as follows:

```
  <workspace>
    <tool>
      <tool type>driver/TV</tool type>
      <tool link>http://a.b.c/driver</tool link>
    </tool>
    < space ID >
      <space ID=″3587AD″>
    < /space ID >
</workspace>
```

After the unified driver 331* is configured in the projected workspace 311 of the first user device 310, the first user 81 has an access right to the accessible article 340. That is, the first user 81 can operate the first user device 310 to execute the unified driver 331* in the projected workspace 311 so as to access the accessible article 340. In this embodiment, the accessible article 340 has an accessible component 341 such as a communication chip. After the connection between the accessible component 341 and the first user device 310 is established by the unified driver 331*, the accessible component 341 can receive the signals from the first user device 310.

Moreover, the accessing techniques between the first user device 310 and the accessible article 340 include wired techniques or wireless techniques. For example, sensors (e.g., infrared sensors), gas transducers, RFID techniques, laser scanners and other appropriate techniques can be used to establish the connection between the first user device 310 and the accessible article 340 in real time during the process of monitoring any object or during the sampling process. Consequently, acoustical, optical, thermal, electrical, mechanical, chemical, biological, positional information and various required information can be correspondingly generated. The above accessing techniques and the types of information to be transmitted are presented herein for purpose of illustration and description only.

For accessing the accessible article 340, the first user 81 can operate the first user device 310 to execute the unified driver 331* in the projected workspace 311. Consequently, the projected workspace 311 will wrap the space ID: 3587AD as an authentication request 313 and send the authentication request 313 to the accessible article 340 via the unified driver 331*. After the authentication request 313 is received by the accessible article 340, the accessible article 340 will check whether a provisioned space ID exists in the accessible article 340. If the provisioned space ID does not exist in the accessible article 340, the space ID: 3587AD wrapped in the authentication request 313 is stored into the accessible article 340. Under this circumstance, the space ID: 3587AD becomes the provisioned space ID.

After the space ID: 3587AD is stored into the accessible article 340 and becomes the provisioned space ID, it means that the accessible article 340 has been authenticated and accessed by the projectable space instance 301. Thereafter, as long as the projectable space instance 301 containing a space ID matching the provisioned space ID in the accessible article is loaded into any user device by the first user 81, it means that the first user 81 has an access right to the accessible article 340. Consequently, the first user 81 can control or manage the accessible article 340 by operating the projected workspace 311 corresponding to the projectable space instance 301.

Conventionally, many smart devices or other products derived from the internet of things (IOT) are basically equipped with the internet access function in order for the user to receive information from a server by uploading the content information or data of these products to the server via a cloud computing techniques (e.g., network server techniques, network service techniques or cloud storage techniques). In accordance with the method of the present invention, the accessible article 340 can directly access or send information/data to the first user device 310, and the first user device 310 can directly control and manage the accessible article 340. Consequently, the accessible article 340 does not necessarily have the internet access function. Since the accessible article 340 is not additionally equipped with a component for implementing the internet access function, the fabricating cost of the accessible article 340 is reduced.

Moreover, the URI corresponding to the projectable space instance 301 can be shared with others by the first user 81. For example, the URI corresponding to the projectable space instance 301 can be shared via a social network. That is, the social network accounts of other users are used as identification objects. Other users can receive the URI corresponding to the projectable space instance 301 through their social network accounts. Preferably but not exclusively, the social network accounts are Line accounts, Whatsapp accounts, Gtalk accounts, email addresses, Skype accounts or Facebook accounts.

In some situations, the social networks are well-known social networks, and the user is able to actively identify the one-way or two-way relationship with other users. In some other situations, the social networks are less-known or implied social networks, and the user develops the one-way or two-way relationship with other users by an implied mechanism. In order to achieve the goal of the present invention, the term “social network” indicates that any two individuals connect or communicate with one another by a computerized mechanism. Some of the social networks may be applied to promote end-to-end communications among users of formal social networks. Other social networks are less formal and include the user's email contact list, telephone list, email list, or other database, wherein the user can initiate or receive communications from the database.

Please refer to FIG. 9 again. When the first user shares the authority of the projectable space instance 301 with a second user 82, the second user 82 can use the second user device 320 to link the web server 300 to acquire the updated content of the projectable space instance 301. That is, the acquired projectable space instance 301 has already contained the unified driver 331* and the space ID: 3587AD. Consequently, a projected workspace 321 is created in the second user device 320. For accessing the accessible article 340, the second user 82 can operate the second user device 320 to execute the unified driver 331* in the projected workspace 321. Consequently, the projected workspace 321 will wrap the space ID: 3587AD as an authentication request 313* and send the authentication request 313* to the accessible article 340 via the unified driver 331*.

Similarly, after the authentication request 313* is received by the accessible article 340, the accessible article 340 will check whether a provisioned space ID exists in the accessible article 340. If the provisioned space ID exists in the accessible article 340, the accessible article 340 performs an authenticating process to compare the space ID (3587AD) wrapped in the authentication request 313* with the provisioned space ID in the accessible article 340. As shown in FIG. 9, the space ID (3587AD) wrapped in the authentication request 313* matches the provisioned space ID in the accessible article 340. In other words, the second user 82 has an access right to the accessible article 340. Consequently, the second user 82 can control or manage the accessible article 340 by operating the projected workspace 321 of the second user device 320.

Moreover, other user may operate an unidentified projectable space instance, wrap the space ID of the projectable space instance as an authentication request and transmit the authentication request to the accessible article 340 in order to intend for acquiring the access right to the accessible article 340. Since the space ID of the unidentified projectable space instance does not match the provisioned space ID in the accessible article 340, the accessible article 340 will realize that the space ID wrapped in the authentication request does not match the provisioned space ID in the accessible article during the authenticating process. Consequently, this user cannot acquire the access right to the accessible article 340. In other words, the accessible article rejects other user to operate other user device to access the accessible article 340.

Moreover, when the manufacturer produces the accessible article, the manufacturer also develops a driver that complies with the same communication protocol as the accessible article. Consequently, the user device with the driver can link, access and control the accessible article. Since different accessible articles are possibly produced by different manufacturers, different independent drivers corresponding to the different accessible articles may have different capabilities, attributes and set-ups. In accordance with the present invention, the above unifying method can be used to unify these drives that are developed by different manufacturers. After the drivers are unified, the unified drivers are provided to the projectable space instance. Consequently, the user can operate the user device to access the projectable space instance in the user device. By executing the plural unified drivers, these different accessible articles can be accessed and controlled accordingly.

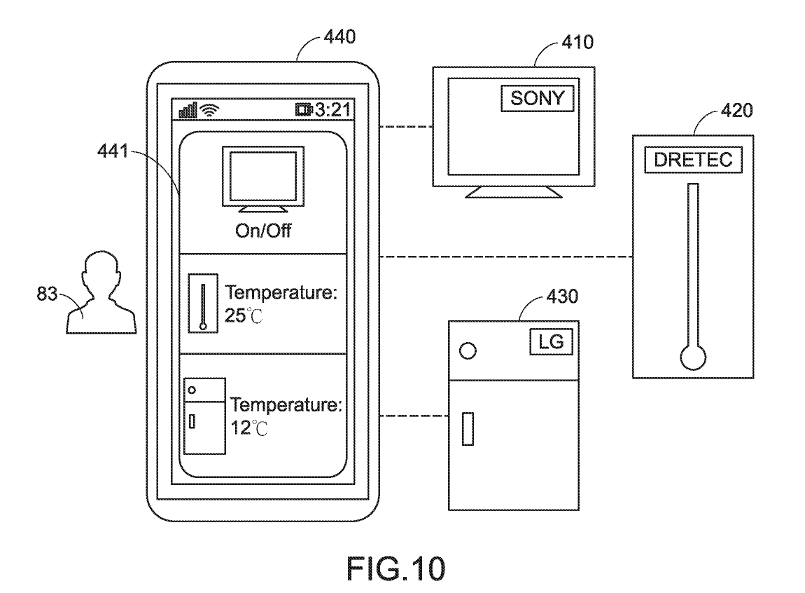

FIG. 10 schematically illustrates an implementation concept of allowing a user to access plural different accessible articles via the user device. As shown in FIG. 10, plural different accessible articles include a Sony TV 410, a Dretec thermometer 420 and a LG refrigerator 430, and the user device 400 is a smart phone. Via a projected workspace 441 created in the smart phone 440, a user 83 can access the TV 410, the thermometer 420 and the refrigerator 430 which are produced from different manufacturers. The basic structure of the projectable space instance corresponding to the projected workspace 441 will be illustrated as follows:

```
  <workspace>
    <tool>
      <tool type>driver/Sony TV</tool type>
      <tool link>http://a.b.c/driver</tool link>
    </tool>
    <tool>
      <tool type>driver/Dretec temperature</tool type>
      <tool link>http://d.e.f/driver</tool link>
    </tool>
    <tool>
      <tool type>driver/LG refrigerator</tool type>
      <tool link>http://g.h.i/driver</tool link>
    </tool>
    < space ID >
      <space ID=″3587AD″>
    < /space ID >
</workspace>
```

The ways of unifying plural drivers which are developed by different manufacturers and accessing and controlling plural accessible articles corresponding to the plural drivers via the same user device may be referred to the China Patent Application No. 201510061132.X, entitled “Method of controlling and managing electronic device and control system using the same”, and also referred to the PCT Application No. PCT/CN2015/082688, entitled “Method of controlling and managing electronic device and control system using the same”. The detailed descriptions thereof are omitted.

In an embodiment, the user 83 can operate the smart phone 440 to execute different drivers in the projected workspace 441. Consequently, the authentication request containing the space ID: 3587AD is transmitted to the corresponding accessible articles (i.e., the TV 410, the thermometer 420 and the refrigerator 430). Moreover, if the space ID: 3587AD wrapped in the authentication request matches the provisioned space IDs in these accessible articles, the user 83 has access rights to these accessible articles. After the user 83 acquires the access rights to these accessible articles, the user 83 can browse associated information of these accessible articles via the projected workspace 441 of the smart phone. For example, the associated information of these accessible articles includes the condition of the power switch of the TV 410, the displayed temperature of the thermometer 420 and the inner temperature of the refrigerator 430. More especially, the user 83 can control the power switch of the TV 410 or adjust the inner temperature of the refrigerator 430 via the projected workspace 441.

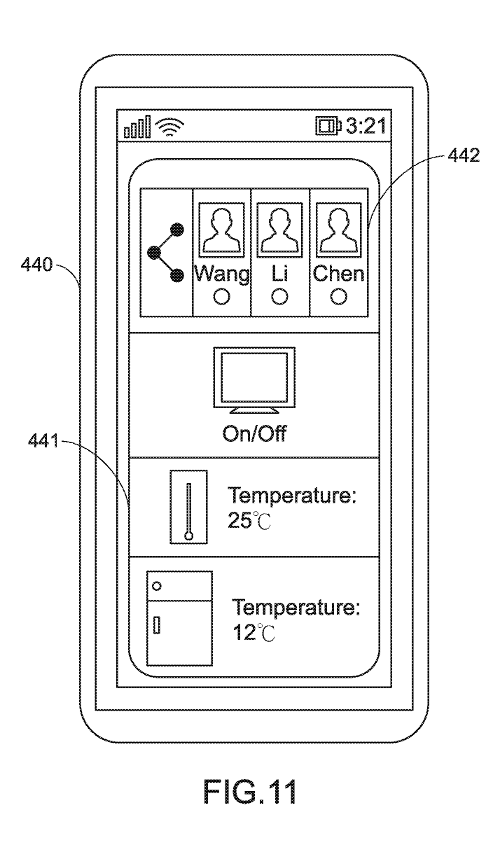

Moreover, the user 83 can share the workspace with other user. FIG. 11 schematically illustrates an implementation concept of allowing a user to share a workspace to other user via the user device of FIG. 10. In FIG. 11, a friend list 442 is shown on the projected workspace 441 of the smart phone 440. For example, the friend list 442 includes a contact list, a colleague list and/or a family list. The URI of the projectable space instance corresponding to the projected workspace 441 can be provided from the user 83 to some specified friends in the friend list 442. After these specified friends receive and open the URI of the projectable space instance, these specified friends and the user possess the same workspace. That is, the user gives authorities to these specified friends to possess the access rights to the workspace.

Moreover, these specified friends can operate their user device to acquire the space ID from the projectable space instance, wrap the space ID as authentication requests, and transmit the authentication requests to the corresponding accessible articles. If the space ID: 3587AD of the projectable space instance matches the provisioned space IDs in these accessible articles, these friends have access rights to these accessible articles. Preferably but not exclusively, the projected workspace 441 of the smart phone 440 has an authority control function. The user 83 can operate the authority control function of the projected workspace 441 to cancel the authorities of these specified friends to use the shared workspace. That is, the user 83 has the authority to cancel the access rights of these specified friends to these accessible articles. Of course, any provisioned space ID in the accessible article can be reset as needed. In FIGS. 10 and 11, the projected workspace 441 is displayed on a two-dimensional interface of the smart phone 440. It is noted that the way o displaying the projected workspace is not restricted. For example, in another embodiment, the projected workspace is displayed on the interface of the user device in a three-dimensional or four-dimensional environment.

From the above descriptions, the present invention provides a method for accessing an accessible article. The method of the present invention has the following advantages. Firstly, the user can establish authentication between the user device and the accessible article via the projectable space instance containing the space ID, so that the user device acquires the access right to the accessible article. That is, the user can control and manage the accessible article via the user device and receive associated inner information from the accessible article. Secondly, unifying method of the present invention can be used to unify different or incompatible drivers that are developed by different manufacturers. After the drivers are unified, the unified drivers are provided to the projectable space instance. Consequently, the projectable space instance can integrate plural different or incompatible drivers or application programs. Under this circumstance, the user can control and manage plural accessible articles via the user device equipped with the projectable space instance. Thirdly, the method of the present invention allows the user to share the projectable space instance with other users. After the authentication between the accessible article and the projectable space instance containing the space ID is established by the user, the user can share the projectable space instance containing the space ID with other users. That is, the user gives authorities to other users to possess the access rights to the accessible article. Consequently, after other users receive and acquire the projectable space instance containing the space ID, they can create the corresponding projected workspace in the user devices in order to control and manage the accessible article. Fourthly, in accordance with the method of the present invention, the accessible article can directly access or send information/data to the user device, and the user device can directly control and manage the accessible article. Consequently, the accessible article does not necessarily have the internet access function. Since the accessible article is not additionally equipped with a component for implementing the internet access function, the fabricating cost of the accessible article is reduced.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A method for accessing an accessible article, the method comprising steps of:
(a) providing a projectable space instance for modeling a workspace so as to manage an access right to the accessible article;
(b) parsing the projectable space instance, so that the workspace is projected to a user device;
(c) acquiring a space ID from the projectable space instance, wrapping the space ID as an authentication request, and transmitting the authentication request to the accessible article before the accessible article is accessed;
(d) checking whether a provisioned space ID exists in the accessible article; and
(e) if the provisioned space ID exists in the accessible article, the accessible article performing an authenticating process to compare the space ID wrapped in the authentication request with the provisioned space ID in the accessible article, wherein the user device is allowed to access the accessible article if the space ID wrapped in the authentication request matches the provisioned space ID in the accessible article; and
if the provisioned space ID does not exist in the accessible article, storing the space ID wrapped in the authentication request into the accessible article to have the space ID become the provisioned space ID, and allowing the user device to access the accessible article; or
if the provisioned space ID does not exist in the accessible article, storing the space ID wrapped in the authentication request into the accessible article to have the space ID become the provisioned space ID, and the accessible article performing an authenticating process to compare the space ID wrapped in the authentication request with the provisioned space ID in the accessible article, wherein the user device is allowed to access the accessible article if the space ID wrapped in the authentication request matches the provisioned space ID in the accessible article.

2. The method according to claim 1, further comprising a step (b1) of obtaining a unified tool for linking the accessible article via the user device, and adding the unified tool to the projectable space instance via the projected workspace, wherein the step (b1) is performed before the step (c).

3. The method according to claim 2, wherein the unified tool is a produced after a driver is unified, and the driver is provided from the accessible article or another device so as to transmit the authentication request.

4. The method according to claim 1, wherein in the step (e), if the space ID wrapped in the authentication request does not match the provisioned space ID in the accessible article, the accessible article rejects the user device to access the accessible article.

5. The method according to claim 1, wherein the accessible article is a remotely-controllable electronic device; or
the user device is a computer, a portable electronic device or a smart wearable device.

6. (canceled)

7. The method according to claim 1, wherein the projectable space instance is instantiated by a unified script, which is used as an intermediate language for implementing the workspace.

8. The method according to claim 7, wherein an information importer, a unified tool and/or a unified information unit is provided to the workspace via the unified script.

9. The method according to claim 1, wherein the projectable space instance has a uniform resource identifier to be transmitted.

10. The method according to claim 9, wherein the projectable space instance is parsed when the uniform resource identifier is opened, so that the workspace is projected to the user device.

11. The method according to claim 1, wherein in the step (b), a projector is used to parse the projectable space instance to build a working environment, wherein an information importer, a unified tool and/or a unified information unit is configured in the projectable space instance via the working environment.

12. The method according to claim 1, wherein if the space ID wrapped in the authentication request matches the provisioned space ID in the accessible article and a first user of the user device shares an authority of the projectable space instance with a second user, the second user acquires the access right to the accessible article.

13. The method according to claim 12, wherein the first user has an authority to cancel the access right of the second user to the accessible article.

14. The method according to claim 1, wherein the provisioned space ID is reset as needed; or
the space ID is a content or an image.

15. The method according to claim 1, wherein the projectable space instance contains a driver corresponding to the accessible article and an additional driver corresponding to an additional accessible article, wherein the accessible article and the additional accessible article are accessed by the driver and the additional driver, respectively.

16. (canceled)

17. A system, comprising:
an accessible article; and
a user device, wherein after a projectable space instance for managing an access right to the accessible article is loaded to the user device and the parsed, a projected workspace is created in the user device, wherein the projected workspace acquires a space ID from the projectable space instance, wraps the space ID as an authentication request, and transmits the authentication request to the accessible article before the accessible article is accessed, wherein after the accessible article receives the authentication request, the accessible article checks whether a provisioned space ID exists in the accessible article,
wherein if the provisioned space ID exists in the accessible article, the accessible article performs an authenticating process to compare the space ID wrapped in the authentication request with the provisioned space ID in the accessible article, wherein the user device is allowed to access the accessible article if the space ID wrapped in the authentication request matches the provisioned space ID in the accessible article; and
wherein if the provisioned space ID does not exist in the accessible article, the space ID wrapped in the authentication request is stored into the accessible article to have the space ID become the provisioned space ID, and the user device is allowed to access the accessible article; or
wherein if the provisioned space ID does not exist in the accessible article, the space ID wrapped in the authentication request is stored into the accessible article to have the space ID become the provisioned space ID, and the accessible article performs an authenticating process to compare the space ID wrapped in the authentication request with the provisioned space ID in the accessible article, wherein the user device is allowed to access the accessible article if the space ID wrapped in the authentication request matches the provisioned space ID in the accessible article.

18. The system according to claim 17, wherein a unified tool for linking the accessible article is added to the projectable space instance via the projected workspace.

19. The system according to claim 18, wherein the unified tool is a produced after a driver is unified, and the driver is provided from the accessible article or another device so as to transmit the authentication request.

20. An accessible article for receiving an authentication request from a projected workspace of a user device, the projected workspace being created in the user device after a projectable space instance loaded into the user device is parsed, an space ID from the projectable space instance being wrapped as the authentication request, wherein after the accessible article receives the authentication request, the accessible article performs steps of:
(a) checking whether a provisioned space ID exists in the accessible article; and
(b) if the provisioned space ID exists in the accessible article, the accessible article performing an authenticating process to compare the space ID wrapped in the authentication request with the provisioned space ID in the accessible article, wherein the user device is allowed to access the accessible article if the space ID wrapped in the authentication request matches the provisioned space ID in the accessible article; and
if the provisioned space ID does not exist in the accessible article, storing the space ID wrapped in the authentication request into the accessible article to have the space ID become the provisioned space ID, and allowing the user device to access the accessible article; or
if the provisioned space ID does not exist in the accessible article, storing the space ID wrapped in the authentication request into the accessible article to have the space ID become the provisioned space ID, and the accessible article performing an authenticating process to compare the space ID wrapped in the authentication request with the provisioned space ID in the accessible article, wherein the user device is allowed to access the accessible article if the space ID wrapped in the authentication request matches the provisioned space ID in the accessible article.

21. The accessible article according to claim 20, wherein a unified tool for linking the accessible article is added to the projectable space instance via the projected workspace.

22. The accessible article according to claim 21, wherein the unified tool is a produced after a driver is unified, and the driver is provided from the accessible article or another device so as to transmit the authentication request.
